(19) United States
(12) Patent Application Publication
(10) Pub. No.: US 2022/0044268 A1
(43) Pub. Date: Feb. 10, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Keisuke SHOJI, Nagoya-shi (JP); Yurika TANAKA, Yokosuka-shi (JP); Satoshi KOMAMINE, Nagoya-shi (JP); Hideo HASEGAWA, Nagoya-shi (JP); Tomoya MATSUBARA, Seto-shi (JP); Ibuki SHIMADA, Miyoshi-shi (JP); Shuhei YAMAMOTO, Aichi-gun (JP)

(73) Assignee: TOYOTA JIDOSHA KABUSHIKI KAISHA, Toyota-shi (JP)

(21) Appl. No.: 17/372,068

(22) Filed: Jul. 9, 2021

(30) Foreign Application Priority Data
Aug. 6, 2020 (JP) 2020-133805

(51) Int. Cl. G06Q 30/02; G06K 9/00; G08B 21/22

(52) U.S. Cl. CPC G06Q 30/0207; G08B 21/22; G06K 9/00838

(57) ABSTRACT

A controller is provided that is configured to perform: specifying a first user who is a user before boarding a moving vehicle; specifying a second user who is a user sitting on a seat in the moving vehicle; transmitting an inquiry to a terminal of the second user about whether or not to offer his or her seat; and notifying a terminal of the first user that the first user can take a seat in the moving vehicle, when a response to the effect that a seat is offered is received from the terminal of the second user.

### CROSS REFERENCE TO THE RELATED APPLICATION

This application claims the benefit of Japanese Patent Application No. 2020-133805, filed on Aug. 6, 2020, which is hereby incorporated by reference herein in its entirety.

### BACKGROUND

### Technical Field

The present disclosure relates to an information processing apparatus, an information processing method, and a non-transitory storage medium storing a program.

### Description of the Related Art

There is known a technology in which passengers seated in a bus are notified to offer their seats in cases where an elderly person, a physically handicapped person and the like are in the bus (for example, refer to Patent Literature 1).

### CITATION LIST

### Patent Literature

Patent Literature 1: Japanese Patent Application Laid-Open Publication No. 2004-295686

### SUMMARY

Whether or not a user will be able to be offered a seat will not be known until the user boards a moving body or vehicle. Even if a user boards a moving vehicle, the user will not be able to take a seat in cases where there is no passenger willing to offer his or her seat. The object of this disclosure is to increase the probability that a user can take a seat when the user boards a moving vehicle.

One aspect of the present disclosure is directed to an information processing apparatus including a controller configured to execute:

specifying a first user who is a user before boarding a moving vehicle;

specifying a second user who is a user sitting on a seat in the moving vehicle;

transmitting an inquiry to a terminal of the second user about whether or not to offer his or her seat; and

notifying a terminal of the first user that the first user can take a seat in the moving vehicle, when a response to the effect that a seat is offered is received from the terminal of the second user.

Another aspect of the present disclosure is directed to an information processing method for causing a computer to perform:

specifying a first user who is a user before boarding a moving vehicle;

specifying a second user who is a user sitting on a seat in the moving vehicle;

transmitting an inquiry to a terminal of the second user about whether or not to offer his or her seat; and

notifying a terminal of the first user that the first user can take a seat in the moving vehicle, when a response to the effect that a seat is offered is received from the terminal of the second user.

A further aspect of the present disclosure is directed to a non-transitory storage medium storing a program configured to cause a computer to perform:

specifying a first user who is a user before boarding a moving vehicle;

specifying a second user who is a user sitting on a seat in the moving vehicle;

transmitting an inquiry to a terminal of the second user about whether or not to offer his or her seat; and

notifying a terminal of the first user that the first user can take a seat in the moving vehicle, when a response to the effect that a seat is offered is received from the terminal of the second user.

In addition, a yet further aspect of the present disclosure is directed to the program as described above.

According to the present disclosure, it is possible to increase the probability of a user being able to take a seat, when the user boards a moving vehicle.

### BRIEF DESCRIPTION OF THE DRAWINGS

FIG. 1 is a diagram illustrating a schematic configuration of a system according to an embodiment;

FIG. 2 is a block diagram schematically illustrating an example of a configuration of each of a camera, a first user terminal, a second user terminal, and a server, which together constitute the system according to the embodiment;

FIG. 3 is a diagram illustrating an example of a functional configuration of the server;

FIG. 4 is a diagram illustrating an example of a table structure of a user information DB;

FIG. 5 is a diagram illustrating an example of a table structure of an image information DB;

FIG. 6 is a diagram illustrating a functional configuration of a user terminal;

FIG. 7 is a flowchart of the processing of transmitting user information from the user terminal to the server according to a first embodiment;

FIG. 8 is a flowchart of the processing of the server transmitting a first request to the second user terminal according to the first embodiment;

FIG. 9 is a flowchart of second user selection processing according to the first embodiment;

FIG. 10 is a flowchart of processing at the time when the second user terminal receives the first request from the server according to the first embodiment;

FIG. 11 is a flowchart of processing at the time when the second user terminal receives first user information from the server according to the first embodiment;

FIG. 12 is a flowchart of processing at the time when the first user terminal receives second user information from the server according to the first embodiment; and

FIG. 13 is a flowchart of the processing of a server rewarding a second user according to a second embodiment.

### DESCRIPTION OF THE EMBODIMENTS

An information processing apparatus, which is one aspect of the present disclosure, is provided with a controller. The controller is configured to specify a first user who is a user before boarding a moving body or vehicle. The fact that the first user boards or gets on a moving vehicle and the moving vehicle which the first user takes can be determined based on, for example, position information of a terminal of the first user, or information inputted or entered into the terminal by the first user or a search result in the case where the first user has performed a route search by using his or her terminal. Here, note that the first user may be a user who wants to take a seat in the moving vehicle. Whether or not a user wants to take a seat can be determined based on, for example, an attribute of the user. For example, a user having an attribute such as an injured person, a sick person, a handicapped person, a pregnant woman, a user with children, an elderly person, a fatigued user or the like may be considered to want to take a seat. The attribute of the user may be determined based on, for example, information transmitted from the terminal of the user.

In addition, the controller specifies a second user who is a user sitting on a seat of the moving vehicle. The second user is a user who is already on the moving vehicle. Whether or not a user is on the moving vehicle can be determined, for example, by comparing the position information of the terminal of the user with the position information of the moving vehicle. The position information of the moving vehicle may be estimated based on service (operation) information thereof or the like. Whether or not a user is sitting on a seat in the moving vehicle can be determined, for example, by analyzing an image taken by a camera provided in the moving vehicle or using the position information of the terminal of the user. Here, note that the second user may be a user other than the one who should be seated, such as an injured person, a sick person, a handicapped person, a pregnant woman, a user with children, an elderly person, a fatigued user or the like.

Moreover, the controller transmits an inquiry to a terminal of the second user as to whether or not the second user can offer his or her seat. In response to this inquiry, the second user will respond whether or not to offer his or her seat. Therefore, the second user can also refuse to offer his or her seat to the first user. When receiving a response from the terminal of the second user to the effect that the second user offers his or her seat, the controller notifies the terminal of the first user that the first user can take a seat in the moving vehicle. In this way, the first user can board the moving vehicle after confirming that he or she can take a seat in the moving vehicle. Here, note that the controller may provide a reward to the second user who has offered his or her seat to the first user.

Further, in cases where the controller has not received a response from the terminal of the second user sitting on a seat in the moving vehicle to the effect that the second user will offer his or her seat to the first user before the time point when the first user boards the moving vehicle, the controller specifies a new second user from among users who are sitting on seats in a second moving vehicle that departs later than the first-mentioned moving vehicle, and transmits an inquiry to a terminal of the newly specified second user as to whether or not to offer his or her seat to the first user, and in cases where the controller receives a response from the terminal of the newly specified second user to the effect that the new second user can offer his or her seat, the controller may notify the terminal of the first user that the first user can take a seat in the second moving vehicle. That is, in cases where there is no second user who can offer his or her seat to the first user in the first-mentioned moving vehicle which the first user is scheduled to take, a new second user who can offer his or her seat to the first user is searched for from among the users in the second moving vehicle. A second user may continue to be searched for in other moving vehicles until the second user is found who can offer his or her seat to the first user.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

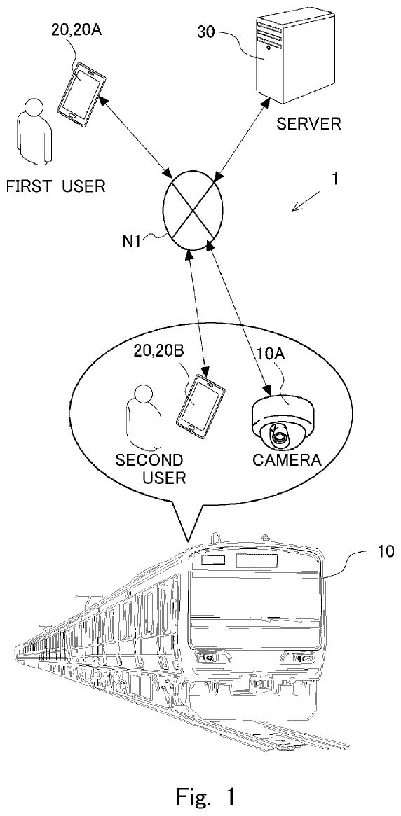

FIG. 1 is a diagram illustrating a schematic configuration of a system 1 according to a first embodiment. The system 1 is a system that inquires, to a second user terminal 20B of a second user who is already on a train 10, whether or not the second user is acceptable to offer his or her seat to a first user, when the first user having a first user terminal 20A is about to board the train 10. When there is a response from the second user terminal 20B to the server 30 to the effect that the seat will be offered, the server 30 transmits the effect to the first user terminal 20A. Since the first user can board the train 10 on which the second user who will offer his or her seat is riding, the first user can take a seat more surely. Accordingly, for example, a person who needs to sit down, such as an injured person, a sick person, a handicapped person, a pregnant woman, a person with children, an elderly person, a fatigued person or the like, can do so more surely.

If there is no second user who will offer his or her seat in the train 10, the server 30 may inquire the passengers of the next train 10 after that train 10 whether to offer their seats. Then, the server 30 may transmit to the first user terminal 20A information about the train 10 on which a second user who will offer his or her seat is riding. In this way, the first user searches for a second user until the second user who will offer his or her seat appears, so that the first user can sit on the seat more surely.

In the example of FIG. 1, the system 1 includes a camera 10A arranged in the train 10, the first user terminal 20A, the second user terminal 20B, and the server 30. The train 10 is provided with seats, and users can also ride on the train 10 while standing. The camera 10A takes an image of an inside of the train 10. In addition, the camera 10A is arranged in such a way that it can take an image of second users sitting on the seats in the train 10. The train 10 is an example of the moving body or vehicle. As another example of the moving body or vehicle, there can be mentioned a passenger vehicle such as a bus or the like.

The first user terminal 20A is a terminal used by the first user, and the second user terminal 20B is a terminal used by the second user. Here, note that in the following description, in cases where the first user terminal 20A and the second user terminal 20B are not distinguished from each other, the first user terminal 20A and the second user terminal 20B are each simply referred to as a user terminal 20. Also, in cases where the first user and the second user are not distinguished from each other, the first user and the second user are each simply referred to as a user. Note that the same user can be a first user or a second user, depending on a situation. For example, in the case of a user with children, the user can be a first user when he or she is with children, and a second user when he or she is not with children. Accordingly, the same user terminal 20 can be a first user terminal 20A or a second user terminal 20B.

The camera 10A, the first user terminal 20A, the second user terminal 20B and the server 30 are connected to one another by means of a network N1. The network N1 is, for example, a worldwide public communication network such as the Internet, and a wide area network (WAN) or other communication networks may be adopted. In addition, the network N1 may include a telephone communication network such as a mobile phone network or the like, or a wireless communication network such as Wi-Fi (registered trademark) or the like. Here, note that in FIG. 1, one camera 10A, one first user terminal 20A and one second user terminal 20B are exemplarily illustrated, but there can be a plurality of these components for each of them.

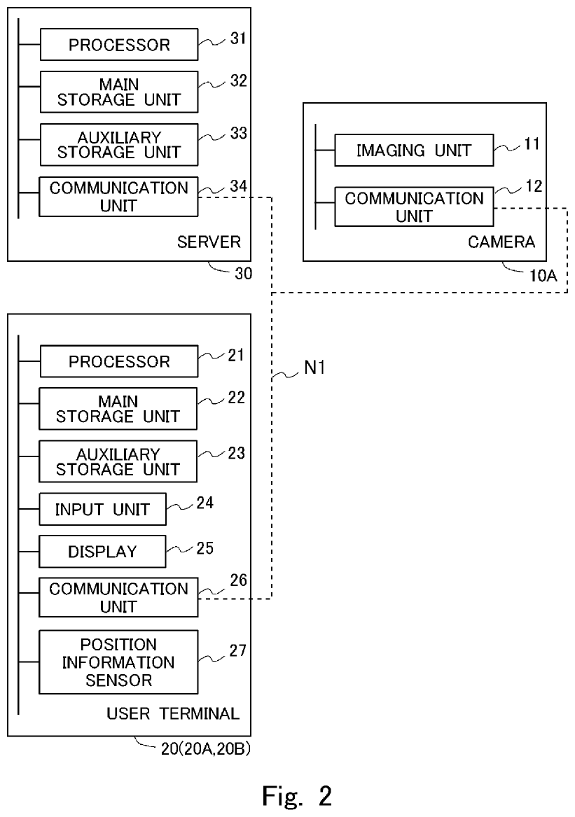

The hardware and functional configurations of the camera 10A, the first user terminal 20A, the second user terminal 20B, and the server 30 will be described based on FIG. 2. FIG. 2 is a block diagram schematically illustrating an example of the configuration of each of the camera 10A, the first user terminal 20A, the second user terminal 20B, and the server 30 which together constitute the system 1 according to the present embodiment.

The server 30 has a configuration of a general computer. The server 30 includes a processor 31, a main storage unit 32, an auxiliary storage unit 33, and a communication unit 34. These components are connected to one another by means of a bus. The processor 31 is an example of a controller.

The processor 31 is a CPU (Central Processing Unit), a DSP (Digital Signal Processor), or the like. The processor 31 controls the server 30 thereby to perform various information processing operations. The main storage unit 32 is a RAM (Random Access Memory), a ROM (Read Only Memory), or the like. The auxiliary storage unit 33 is an EPROM (Erasable Programmable ROM), a hard disk drive (HDD), a removable medium, or the like. The auxiliary storage unit 33 stores an operating system (OS), various programs, various tables, and the like. The processor 31 loads the programs stored in the auxiliary storage unit 33 into a work area of the main storage unit 32 and executes the programs, so that each of the component units or the like is controlled through the execution of the programs. As a result, the server 30 realizes functions that match predetermined purposes. The main storage unit 32 and the auxiliary storage unit 33 are computer-readable recording media. Here, note that the server 30 may be a single computer or a plurality of computers that cooperate with one another. In addition, the information stored in the auxiliary storage unit 33 may be stored in the main storage unit 32. Also, the information stored in the main storage unit 32 may be stored in the auxiliary storage unit 33.

The communication unit 34 is a means or unit that communicates with the camera 10A and the user terminals 20 via the network N1. The communication unit 34 is, for example, a LAN (Local Area Network) interface board, a wireless communication circuit for radio or wireless communication, or the like. The LAN interface board or the wireless communication circuit is connected to the network N1.

Then, the camera 10A is a device that is arranged inside the train 10 so as to take pictures or images of the inside of the train 10. The camera 10A is provided with an imaging unit 11 and a communication unit 12. The imaging unit 11 takes pictures or images by using an imaging element such as a CCD (Charge Coupled Device) image sensor, a CMOS (Complementary Metal Oxide Semiconductor) image sensor or the like. The images thus obtained by taking pictures may be either still images or moving images.

The communication unit 12 is a communication means or unit for connecting the camera 10A to the network N1. The communication unit 12 is, for example, a circuit for communicating with other devices (e.g., the server 30 or the like) via the network N1 by making use of a radio or wireless communication such as a mobile communication service (e.g., a telephone communication network such as 5G (5th Generation), 4G (4th Generation), 3G (3rd Generation), LTE (Long Term Evolution) or the like), Wi-Fi (registered trademark), Bluetooth (registered trademark) or the like. The images taken by the camera 10A are transmitted to the server 30 through the communication unit 12.

Now, a user terminal 20 will be described. The user terminal 20 is a smart phone, a mobile phone, a tablet terminal, a personal information terminal, a wearable computer (such as a smart watch or the like), or a small computer such as a personal computer (PC). The user terminal 20 includes a processor 21, a main storage unit 22, an auxiliary storage unit 23, an input unit 24, a display 25, a communication unit 26, and a position information sensor 27. These components are connected to one another by means of a bus. The processor 21, the main storage unit 22 and the auxiliary storage unit 23 are the same as the processor 31, the main storage unit 32 and the auxiliary storage unit 33 of the server 30, respectively, and hence, the description thereof will be omitted.

The input unit 24 is a means or unit for receiving an input operation performed by a user, and is, for example, a touch panel, a mouse, a keyboard, a push button, or the like. The display 25 is a means or unit for presenting information to the user, and is, for example, an LCD (Liquid Crystal Display), an EL (Electroluminescence) panel, or the like. The input unit 24 and the display 25 may be configured as a single touch panel display. The communication unit 26 is a communication means or unit for connecting the user terminal 20 to the network N1. The communication unit 26 is, for example, a circuit for communicating with other devices (e.g., the server 30 and the like) via the network N1 by making use of a radio or wireless communication network such as a mobile communication service (e.g., a telephone communication network such as 5G (5th Generation), 4G (4th Generation), 3G (3rd Generation), LTE (Long Term Evolution) or the like), Wi-Fi (registered trademark), Bluetooth (registered trademark) or the like.

The position information sensor 27 obtains position information (e.g., latitude and longitude) of the user terminal 20 at predetermined intervals. The position information sensor 27 is, for example, a GPS (Global Positioning System) receiver unit, a wireless communication unit or the like. The information obtained by the position information sensor 27 is recorded, for example, in the auxiliary storage unit 23 or the like, and transmitted to the server 30.

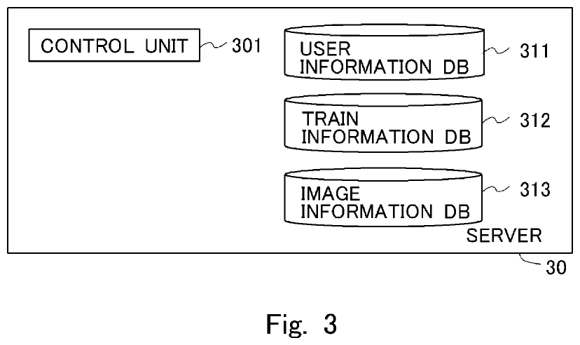

Next, the functions of the server 30 will be described. FIG. 3 is a view illustrating an example of a functional configuration of the server 30. The server 30 includes, as its functional components, a control unit 301, a user information DB 311, a train information DB 312, and an image information DB 313. The processor 31 of the server 30 executes the processing of the control unit 301 by a computer program on the main storage unit 32. The user information DB 311, the train information DB 312, and the image information DB 313 are built by a program of a database management system (DBMS) that is executed by the processor 31 to manage data stored in the auxiliary storage unit 33. The user information DB 311, the train information DB 312 and the image information DB 313 are, for example, relational databases. Here, note that any of the individual functional components of the server 30 or a part of the processing thereof may be executed by another computer connected to the network N1.

The control unit 301 specifies the first user who is a user before boarding the train 10, and is a user who wants to sit on a seat in the train 10. For example, an application for enabling the user to offer his or her seat has been installed on the user terminal 20, and when a predetermined input is made to the application at the user terminal 20, information corresponding to the input is transmitted from the user terminal 20 to the server 30. The control unit 301 specifies the first user based on the information thus transmitted. In addition, as an alternative method, for example, a distance moved or traveled by the user on foot may be estimated from the change over time or transition of the location information of the user terminal 20, and when this distance traveled on foot is equal to or greater than a predetermined distance, the user may be determined to be the first user who wants to sit on a seat in the train 10, because the user is fatigued. Also, as another alternative method, for example, in cases where the user has been registered in advance as a sick person, an injured person, a handicapped person, a pregnant woman, an elderly person, or a user with children, the user may be determined to be the first user who wants to sit on a seat in the train 10. Moreover, as a further alternative method, for example, a message posted from the user terminal 20 to a social networking service (SNS) includes a keyword such as “I got sick”, “I got injured”, “I got pregnant”, “I'm going out with my child”, “I want you to give up your seat”, “I'm going to the doctor (hospital)”, or the like, the user may be determined to be the first user who wants to sit on a seat in the train 10. In this case, the relation between the user and the SNS account thereof may have been registered in the server 30 in advance, so that the control unit 301 may obtain posts of the user from a server that manages the SNS.

In addition, the control unit 301 estimates a train 10 that the first user is scheduled to take or board. The train 10 that the first user is scheduled to take may be estimated based on, for example, the change over time or transition of the position of the user terminal 20, or may be estimated based on operation information about the train 10 provided to the first user when the first user is using a route search via the first user terminal 20A. For example, when the position of the first user obtained from the position information sensor 27 of the user terminal 20 indicates a platform of a station, it can be determined that the first user will board the train 10. In addition, for example, in cases where the first user inputs the train 10 to board to the user terminal 20, the information may be received from the user terminal 20. In addition, for example, if an application for asking users to give up or offer their seats is installed on the user terminal 20, information about the train 10 that the first user will board, transmitted from this application, may be obtained.

Moreover, the control unit 301 specifies a second user who is on the train 10 that the first user will board and who gives up (offers) his or her seat to the first user. Here, note that there is no need to specify a second user in cases where there is a vacant seat in the train 10 that the first user will board, and hence, the control unit 301 may, for example, determine whether or not there is a vacant seat, by analyzing an image taken by the camera 10A, and specify a second user in cases where there is no vacant seat. For example, the control unit 301 selects, from the position information of a user terminal 20 of a second user, the second user who is already on board the train 10 that the first user is scheduled to take.

Then, the control unit 301 transmits an inquiry to the second user about whether or not to give up his or her seat. At this time, the inquiry may be transmitted to second users in the train 10 at random regardless of whether or not the second users are sitting on their seats, or the inquiry may be transmitted to a specific second user who is sitting on his or her seat. Whether or not the second user is sitting on his or her seat may be determined by, for example, whether or not the position information of the user terminal 20 of the second user indicates that the user terminal 20 is over the seat of the second user, or whether or not the second user is sitting on his or her seat may be determined by analyzing an image taken by the camera 10A. In addition, the control unit 301 may determine whether or not the second user is standing or sitting, based on the analysis of an image taken by the camera 10A and the position information of the user terminal 20. The second user sitting on a seat may be specified by analyzing an image of the face of the second user sitting on the seat. In this case, the image of the face of the user associated with the user terminal 20 may have been stored in advance in the auxiliary storage unit 33 of the server 30. The second user may be a user who does not correspond to a sick person, an injured person, a handicapped person, a pregnant woman, an elderly person, a user with children, a fatigued user, or the like. This determination can be made in the same manner as in the case of the first user.

The control unit 301 stores information about the user received from the user terminal 20 in the user information DB 311. Note that in the following, the information about the user is also referred to as user information. The user information includes the position information of the user terminal 20, information about the train 10 that the first user is to board, information about the train 10 on which the second user is riding, and the attribute of the first user. The information about the train 10 that the first user is to board is, for example, information that enables the first user to determine which train 10 the first user is to board, such as, for example, the result of a route search performed at the first user terminal 20A or information entered during the route search. The route search also includes services such as transfer guidance of the train 10 or the like. The attribute of the first user is information capable of determining whether or not the first user wants to sit on a seat on the train 10, e.g., information capable of determining whether or not the first user is an injured person, a sick person, a handicapped person, a pregnant woman, an elderly person, a user with children, or a fatigued user.

Further, the control unit 301 obtains train information from another server or the like that manages the operation of trains, and stores the train information in the train information DB 312. The train information includes the operation information of trains 10. The operation information includes, for example, an arrival time at each station, a departure time from each station, each departure station, a terminal station, a current location, and so on of each train 10.

In addition, the control unit 301 obtains images taken by the camera 10A, and stores the images in the image information DB 313. By analyzing these images, the control unit 301 determines whether or not there is a vacant seat in a train 10, specifies users who are sitting, or determines whether or not a second user has given up (offered) his or her seat to the first user.

Here, note that in cases where there are a plurality of users who can be second users, the control unit 301 may select, for example, a second user from among the plurality of second user candidates at random. Alternatively, the control unit 301 may select, as a second user, a user who is closest to an entrance or doorway of the train 10 from among the plurality of second user candidates. Also, the second user is not limited to one person, but a plurality of persons may be selected.

When selecting the second user, the control unit 301 generates a request to offer a seat (hereinafter referred to as a first request). The first request includes an inquiry about whether or not to offer a seat to the first user. The control unit 301 generates a request for the second user to offer his or her seat to the first user. This first request includes, for example, information to display on the display 25 of the second user terminal 20B that the second user is asked to offer his or her seat. In addition, the first request may include, for example, information capable of specifying the first user. Then, the control unit 301 transmits the first request thus generated to the second user terminal 20B of the selected second user.

However, the selected second user can also refuse to offer his or her seat. For example, when information to the effect that the second user refuses to offer his or her seat is received from the second user terminal 20B in response to the first request, the control unit 301 selects another second user. In this manner, a second user is selected in a repeated manner. However, it is also considered that there may not be any second user who will offer his or her seat in the train 10 that the first user is scheduled to take. In order to cope with this, the control unit 301 selects a second user from among those trains 10 that will depart later than the train that the first user is scheduled to take. In this way, a second user is selected by changing trains 10 until a train 10 with a second user who will offer his or her seat to the first user is found.

When receiving a response from a second user terminal 20B to the effect that a second user will offer his or her seat, the control unit 301 transmits information about the second user (hereinafter, also referred to as “second user information”) to the first user terminal 20A, and at the same time transmits information about the first user (hereinafter also referred to as “first user information”) to the second user terminal 20B. For example, the second user information includes information capable of specifying the second user, information capable of specifying the train on which the second user is riding, or information capable of specifying the seat on which the second user is sitting. Also, for example, the first user information includes information capable of specifying the first user.

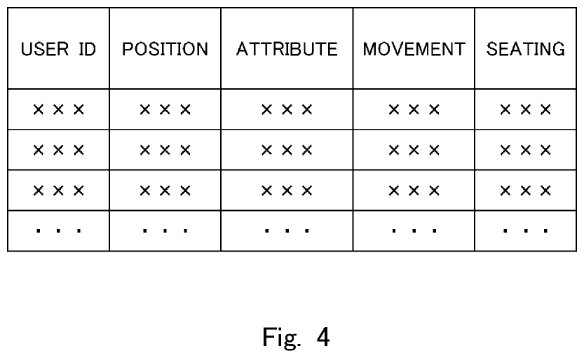

Then, the structure of the user information stored in the user information DB 311 will be explained based on FIG. 4. FIG. 4 illustrates an example of a table structure of the user information DB 311. The user information table includes fields for user ID, position, attribute, movement, and seating. In the user ID field, identification information unique to a user (which may also be a user terminal 20) is inputted or entered. The user ID is assigned to each user or each user terminal 20 by the control unit 301. In the position field, the position information transmitted from each user terminal 20 is entered. In the attribute field, the attribute of each user is entered. The attribute of each user may have been registered in advance via his or her user terminal 20. In addition, the attribute of each user may be transmitted from his or her user terminal 20 at each predetermined time interval. In the attribute field, information capable of determining whether or not the user wants to be given a seat, such as for example the user's health condition, the degree of fatigue, the age, and whether or not the user is with children, or the like, is entered.

In the movement field, information about the user's movement is entered. In the movement field, information capable of specifying a train 10 that the first user is scheduled to take, or information capable of specifying a train 10 on which the second user is riding, is entered. The movement field includes, for example, information about a route search that has been entered into each user terminal 20. Note that a departure place and a destination place of each user may be entered in the movement field. These pieces of information are transmitted from each user terminal 20. Based on the departure place, the destination place and the current location, it is possible to estimate a train 10 that the user is scheduled to take, or it is possible to make an estimation that the user will take a train 10 guided by the route search. In cases where the user is on board a train 10, the train 10 on which the user is riding can also be estimated from the position information of the user. For example, the train 10 on which the user is riding can be estimated by comparing the current location of each train 10, which is estimated based on the information stored in the train information DB 312, with the current location and the direction of movement (travel) of the user.

Information capable of determining whether or not a user on board the train 10 is sitting on his or her seat is inputted or entered into the seating field. For example, the control unit 301 may determine, based on the position information entered in the position field, whether or not the user is seated in the train 10, and may enter the result of the determination into the seating field.

Next, the train information DB 312 stores, for example, the departure station, the stop stations, the terminal station, the time of arrival at each station, and the time of departure from each station, the current location, etc., of each train 10. These pieces of information may be obtained from a server that manages the operation of the trains 10.

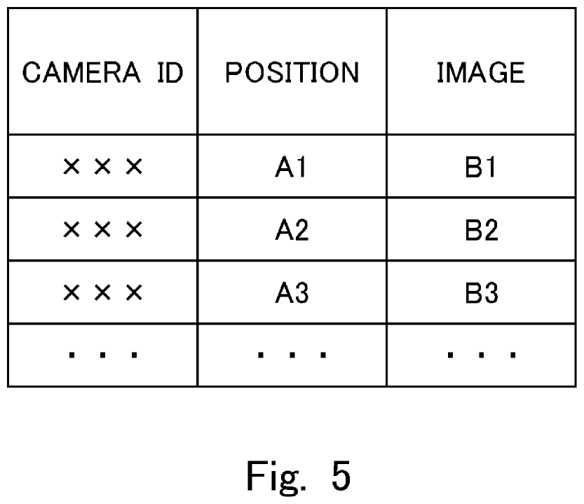

Then, the structure of the image information stored in the image information DB 313 will be described based on FIG. 5. FIG. 5 is a diagram illustrating a table structure of the image information DB 313. The image information table includes fields for camera ID, position, and image. In the camera ID field, identification information (camera ID) unique to each camera 10A is entered. The control unit 301 assigns a camera ID to each camera 10A. Information about the position where each camera 10A is arranged is entered in the position field. The information about the position of each camera 10A includes, for example, information for specifying a train 10 in which the camera 10A is arranged and information for specifying in which car of the train 10 the camera 10A is arranged. That is, information capable of determining in which train 10 and in which car an image has been taken by each camera 10A is entered. The information about the position of each camera 10A may have been registered in advance, or may be transmitted from each camera 10A together with an image taken. An image taken by each camera 10A is entered in the image field. The image taken by each camera 10A is transmitted to the server 30 together with its camera ID.

Next, the function of each camera 10A will be described. The camera 10A takes a picture or image by the imaging unit 11, for example, at each predetermined time interval. Then, the images thus taken are transmitted to the server 30 via the communication unit 12. Specifically, the images taken by the imaging unit 11 are transmitted to the server 30 via the communication unit 12 in association with its camera ID.

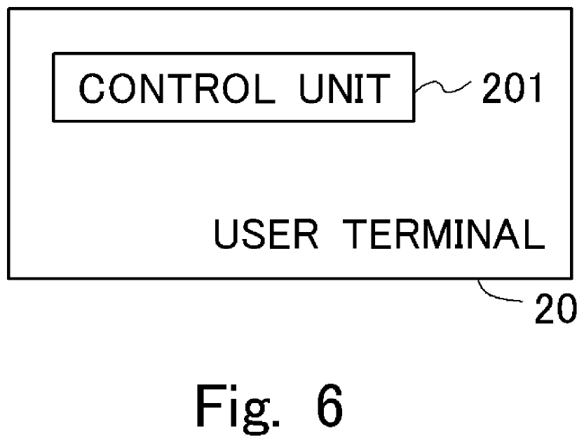

Hereafter, the functions of each user terminal 20 will be described. FIG. 6 is a view illustrating an example of a functional configuration of the user terminal 20. The user terminal 20 includes a control unit 201 as its functional component. The processor 21 of the user terminal 20 executes the processing of the control unit 201 by a computer program on the main storage unit 22.

The control unit 201 transmits the user information to the server 30 at predetermined time intervals. The user information includes position information of the user terminal 20, information about the attribute of the user, and information for specifying the train 10 that the user is scheduled to take. The control unit 201 transmits an output from the position information sensor 27 to the server 30 as position information.

In addition, the information about the train 10 that the user is scheduled to take is, for example, information capable of determining which train 10 the user will take, such as a result of route search performed in the user terminal 20. The control unit 201 transmits, for example, information about the route search performed by the user at the user terminal 20 to the server 30 as information about the train 10 that the user is scheduled to take. The control unit 201 transmits the information entered via the input unit 24 to the server 30, for example, when an application for performing a route search is used. Alternatively, in cases where an application for asking people to offer their seats is installed on the user terminal 20, the information entered via the input unit 24 when this application is used may be transmitted to the server 30. In cases where the server 30 determines, based on the user's position information, which train 10 the user is scheduled to take, it is sufficient to transmit the user's position information as the information about the train 10 that the user is scheduled to take.

Moreover, the attribute of the user is information capable of determining whether or not the user wants to sit in a seat in the train 10, or whether or not the user is able to offer his or her seat in the train 10. The attribute of the user is, for example, information capable of determining whether or not the user is an injured person, a sick person, a handicapped person, a pregnant woman, an elderly person, or a user with children. This information may have been entered in advance into the user terminal 20 by the user. Alternatively, the attribute of the user may be information capable of determining the degree of fatigue of the user. For example, the distance the user has moved or traveled on foot may be estimated from the transition or change over time of the position information of the user terminal 20, and when this traveled distance is equal to or greater than the predetermined distance, it may be determined that the user wants to take a seat. In this case, as the attribute of the user, the distance traveled by the user on foot may be transmitted from the user terminal 20, or information indicating whether or not the degree of fatigue of the user exceeds a threshold value for taking a seat may be transmitted.

Further, the control unit 201 displays, for example, the information received from the server 30 on the display 25. For example, when receiving a first request from the server 30, the control unit 201 displays information about the first request on the display 25. Furthermore, upon receiving the first request, the control unit 201 displays on the display 25 a text or image that prompts the user to enter a response to the first request. Then, the control unit 201 obtains a user's response to the first request via the input unit 24, and transmits it to the server 30.

In addition, when receiving the first user information from the server 30, the control unit 201 displays the information about the first user information on the display 25. When a response to the first request is made to the effect that a seat will be offered, the first user information is transmitted from the server 30. The first user information includes, for example, a request to offer a seat and information capable of specifying the first user to whom the seat is to be offered. The information capable of specifying the first user to whom the seat is to be offered may be, for example, information about the appearance, age, gender, and the like of the first user. Also, for example, in cases where the first user terminal 20A and the second user terminal 20B recognize each other through short-range wireless communication, the information necessary to communicate with the user terminal 20 of the other party may be transmitted to each of the user terminals 20.

Moreover, when receiving the second user information from the server 30, the control unit 201 displays the information about the second user information on the display 25. The second user information includes, for example, a notification that a seat can be offered and information capable of specifying a second user who can offer the seat. The information capable of specifying the second user who can offer his or her seat may be, for example, information about the departure time of the train 10 on which the second user is riding, information about the position where the second user is sitting, and information about the appearance, age, gender, and the like of the second user.

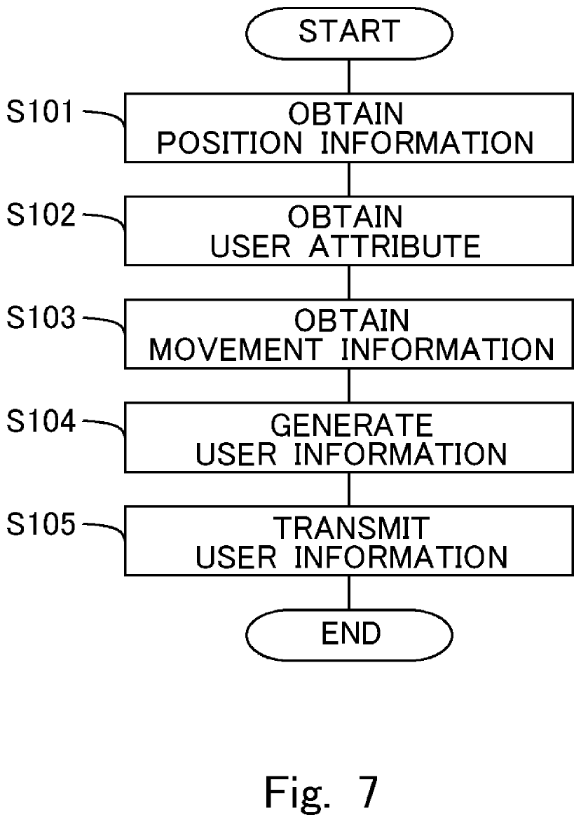

Hereafter, processing for transmitting user information from a user terminal 20 of a user to the server 30 will be described. FIG. 7 is a flowchart of processing for transmitting user information from the user terminal 20 to the server 30 according to the present embodiment. The processing illustrated in FIG. 7 is executed at each predetermined time interval in the user terminal 20.

In step S101, the control unit 201 obtains position information of the user terminal 20. The position information of the user terminal 20 is obtained from the position information sensor 27. In step S102, the control unit 201 obtains the attribute of the user. For example, the attribute of the user inputted or entered into the user terminal 20 by the user via the input unit 24 has been stored in the auxiliary storage unit 23. The control unit 201 obtains this information. In step S103, the control unit 201 obtains travel or movement information of the user. That is, the control unit 201 obtains information about the train 10 that the user boards or the like. When the user uses a route search via the user terminal 20, the control unit 201 obtains, as movement information, information about the departure place and the destination place entered in the user terminal 20 or information about the result of the search. The movement information has been stored in the auxiliary storage unit 23.

Then, in step S104, the control unit 201 generates user information. The user information includes the position information obtained in step S101, the attribute of the user obtained in step S102, and the movement information obtained in step S103. The control unit 201 associates a user ID with these pieces of information to generate user information. Note that, as another method, in cases where the first user inputs or enters, into the user terminal 20, information to the effect that the first user wants to sit on a seat in the train 10, user information may be generated by associating information indicating the effect with a user ID. Then, in step S105, the control unit 201 transmits the user information thus generated to the server 30.

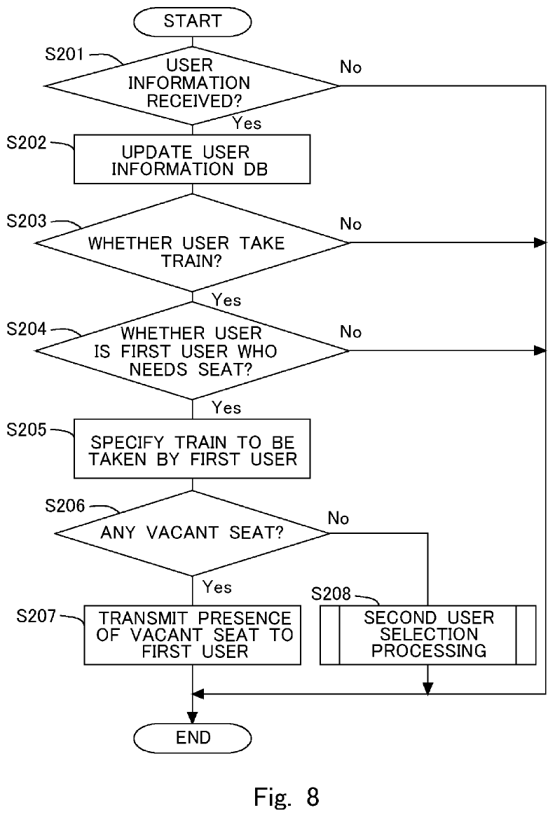

Hereafter, processing in which the server 30 transmits the first request to the second user terminal 20B will be described. FIG. 8 is a flowchart of the processing in which the server 30 transmits the first request to the second user terminal 20B according to the present embodiment. The processing illustrated in FIG. 8 is executed at predetermined time intervals in the server 30.

In step S201, the control unit 301 determines whether or not user information has been received from the user terminal 20. When an affirmative determination is made in step S201, the processing or routine proceeds to step S202, whereas when a negative determination is made, this routine is ended. In step S202, the control unit 301 updates the user information DB 311 by storing the user information thus received in the user information DB 311. In step S203, the control unit 301 determines, based on the received user information, whether or not the user related to the user information is a user who is scheduled to take the train 10. For example, based on the movement information, the control unit 301 may determine whether or not the user is scheduled to take the train 10, or may determine based on the position information whether or not the user is scheduled to take the train 10. For example, in cases where a timetable of a train 10 or the result of a route search is displayed on the user terminal 20 and the position information indicates a platform of a station, it is determined that the user is scheduled to take the train 10. When an affirmative determination is made in step S203, the processing or routine proceeds to step S204, whereas when a negative determination is made, this routine is ended.

In step S204, the control unit 301 determines, based on the received user information, whether or not the user related to the user information is a first user who needs a seat in the train 10. For example, in cases where the attribute of the user is an injured person, a sick person, a handicapped person, a pregnant woman, an elderly person, or a person with children, the control unit 301 determines that the user needs a seat in the train 10. Here, note that, as an alternative, the control unit 301 may determine whether or not the user wants to sit down. In this case, it may be determined whether or not the user information includes information to the effect that the user wants to sit down. When an affirmative determination is made in step S204, the processing or routine proceeds to step S205, whereas when a negative determination is made, this routine is ended.

In step S205, the control unit 301 specifies, based on the user information, the train 10 that the first user will take or board. For example, in cases where the user information includes information on the train 10 guided by the route search, it is considered that the first user will board this train 10. Also, as an alternative, in cases where the position information of the first user indicates a platform of a station, it may be considered that the first user will board the next train 10.

In step S206, the control unit 301 determines whether or not there is a vacant seat in the train 10 that the first user will board. In this step S206, it is determined whether or not it is necessary to select a second user who will offer his or her seat to the first user. For example, the control unit 301 obtains from the image information DB 313 the images taken by the camera 10A that is mounted on the train 10 specified in step S205. Then, the images are analyzed to determine whether or not there is a vacant seat. If there is a vacant seat, it is not necessary to select a second user who will offer his or her seat for the first user. When an affirmative determination is made in step S206, the processing or routine proceeds to step S207, whereas when a negative determination is made, the processing proceeds to step S208. In step S207, the control unit 301 transmits to the first user terminal 20A information for displaying that a seat in the train 10 that the first user will board is vacant, and ends this routine. On the other hand, in step S208, the control unit 301 executes second user selection processing. The second user selection processing will be described later.

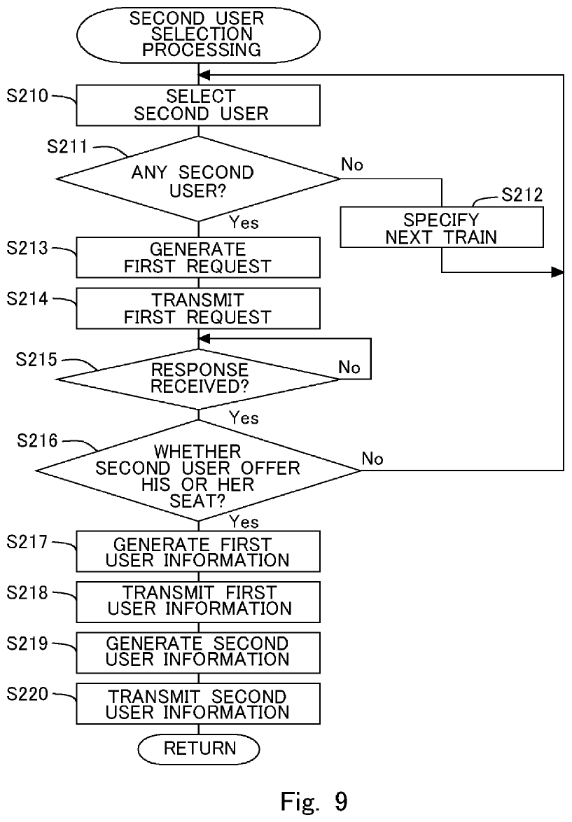

Next, the second user selection processing will be described based on FIG. 9. FIG. 9 is a flowchart of the second user selection processing according to the present embodiment. The second user selection processing is processing executed by the control unit 301 in the step S208 described above. In step S210, the control unit 301 selects a second user (which may be a second user terminal 20B). The control unit 301 selects, as a second user, a user who is already on board the train 10 that the first user is scheduled to take and who is sitting on a seat. For example, a user who possesses a second user terminal 20B that is in the same position as the position of the train 10 estimated based on the operation information of the train 10 is determined to be a user who is already on board the train 10 that the first user is scheduled to take. Also, whether the user is seated or not is determined, for example, based on the position information of the user terminal 20 and the result of analysis of the images taken by the camera 10A. The control unit 301 selects the second user based on the position information stored in the user information DB 311, the train information stored in the train information DB 312, and the image information stored in the image information DB 313. Here, note that in cases where there are a plurality of users corresponding to second users, the plurality of users may be selected as second users, or any one or a predetermined number of users may be selected as the second user(s). At this time, for example, a user closest to an entrance of the train 10 may be selected as the second user. In addition, a user for whom the distance to be traveled by the first user is the shortest may be selected as the second user. Further, the second user may be selected based on the attributes of the users. For example, the control unit 301 may prevent a user from being selected as the second user if the attribute of the user is an injured person, a sick person, a handicapped person, a pregnant woman, an elderly person, or a person with children.

In step S211, the control unit 301 determines whether or not the second user exists. In other words, it is possible that there is no applicable person when the second user is selected in step S210. In such a case, the control unit 301 searches for a vacant (or available) seat on the next train 10 (second moving vehicle). Therefore, when a negative determination is made in step S211, the processing proceeds to step S212, where the control unit 301 specifies a subsequent train 10 that the first user can board. The subsequent train 10 that the first user can board may be a train 10 that arrives at the departure station next to the (first) train 10 specified in step S205 among the trains 10 that stop at the departure station and the arrival or destination station of the first user. In this way, in cases where there is no second user in the first train 10, the control unit 301 further attempts to select a new second user from the next train 10. However, there may be some first users who do not like to wait for a long time, and hence, in cases where there is no second user in the trains 10 that will depart within a predetermined time, this routine may be terminated by notifying the first user terminal 20A to that effect.

On the other hand, if an affirmative determination is made in step S211, the processing proceeds to step S213. In step S213, the control unit 301 generates a first request. Specifically, the control unit 301 generates a request for asking the second user to offer his or her seat to the first user. The first request includes, for example, information for displaying the request for asking to offer the seat on the display 25 of the second user terminal 20B. Also, the first request may include, for example, information that allows the second user to specify the first user. Then, in step S214, the control unit 301 transmits the first request generated in step S213 to the second user terminal 20B of the second user selected in step S210.

In step S215, the control unit 301 determines whether or not a response to the first request has been received from the second user terminal 20B. When an affirmative determination is made in step S215, the processing proceeds to step S216, whereas when a negative determination is made, the processing of step S215 is executed again. Here, note that there may be cases where the user does not make a response, and therefore, for example, when a certain amount of waiting time has elapsed, it may be regarded that the second user has responded that he or she will not offer the seat.

In step S216, the control unit 301 determines whether or not the second user will offer his or her seat. The control unit 301 determines whether or not the response received from the second user terminal 20B is a response indicating that the seat will be offered. When an affirmative determination is made in step S216, the processing proceeds to step S217, whereas when a negative determination is made, the processing returns to step S210 to select another second user. In step S217, the control unit 301 generates first user information. The first user information includes, for example, information capable of specifying the first user. Then, in step S218, the control unit 301 transmits the first user information thus generated to the second user terminal 20B.

In step S219, the control unit 301 generates second user information. The second user information is information by which the first user can specify the second user, and includes, for example, information about the characteristics of the second user, the train 10 on which the second user is riding, and the position of the seat to be offered. Then, in step S220, the control unit 301 transmits the second user information thus generated to the first user terminal 20A. When the processing of step S220 ends, the routine returns to FIG. 8, where the processing of step S208 of FIG. 8 ends, and the routine illustrated in FIG. 8 also ends.

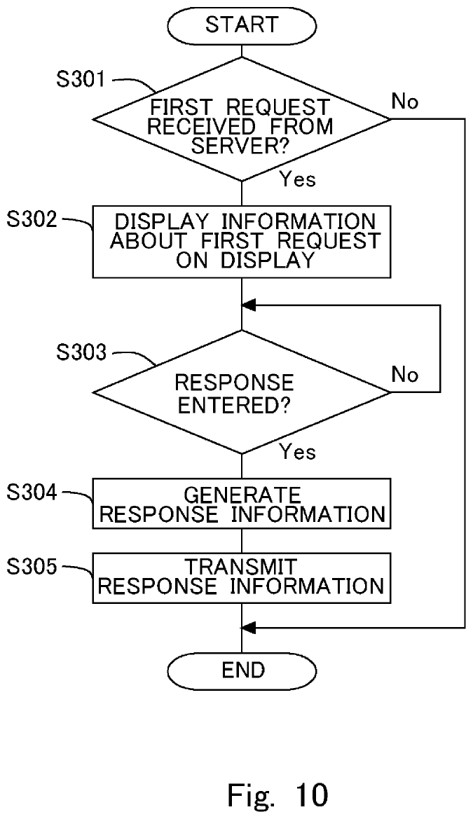

Then, processing when the second user terminal 20B receives the first request will be described. FIG. 10 is a flowchart of the processing when the second user terminal 20B receives the first request from the server 30 according to the present embodiment. The processing illustrated in FIG. 10 is executed at each predetermined time interval in the user terminal 20.

In step S301, the control unit 201 determines whether or not the first request has been received from the server 30. When an affirmative determination is made in step S301, the processing proceeds to step S302, whereas when a negative determination is made, this routine is ended. In step S302, the control unit 201 displays the information about the first request on the display 25. The control unit 201 displays, for example, a text “Will you offer your seat at the next station?” on the display 25. In addition, the control unit 201 displays radio buttons on the display 25, for example, to let the user respond with either “Yes” or “No”.

In step S303, the control unit 201 determines whether or not a response has been entered by the user via the input unit 24. In cases where an affirmative determination is made in step S303, the processing proceeds to step S304, whereas when a negative determination is made, the processing of step S303 is executed again. Here, note that there may be cases where the user does not make a response, and therefore, for example, when a certain period of time has elapsed, it may be regarded that a “NO” response has been entered. In step S304, the control unit 201 generates response information. The response information is information corresponding to the response entered in the input unit 24, and includes, for example, a user ID and information about the response to the first request. Then, in step S305, the control unit 201 transmits the response information to the server 30.

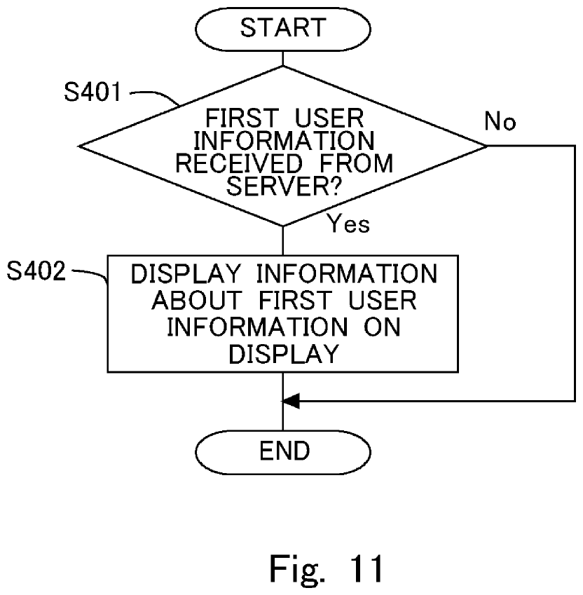

Next, processing when the second user terminal 20B receives the first user information will be described. FIG. 11 is a flowchart of processing when the second user terminal 20B receives the first user information from the server 30 according to the present embodiment. The processing illustrated in FIG. 11 is executed at each predetermined time interval in the user terminal 20.

In step S401, the control unit 201 determines whether or not the first user information has been received from the server 30. When an affirmative determination is made in step S401, the processing proceeds to step S402, whereas when a negative determination is made, this routine is ended. In step S402, the control unit 201 displays the first user information on the display 25. The control unit 201 displays, for example, a text “Please offer your seat at the next station” on the display 25. Also, in cases where information about the first user who is to be offered a seat is included in the first user information, that information may be displayed on the display 25 as well. For example, information that may be useful for specifying the first user, such as gender, age or the like, can be displayed on the display 25 so as to make it easier for the second user to find the first user.

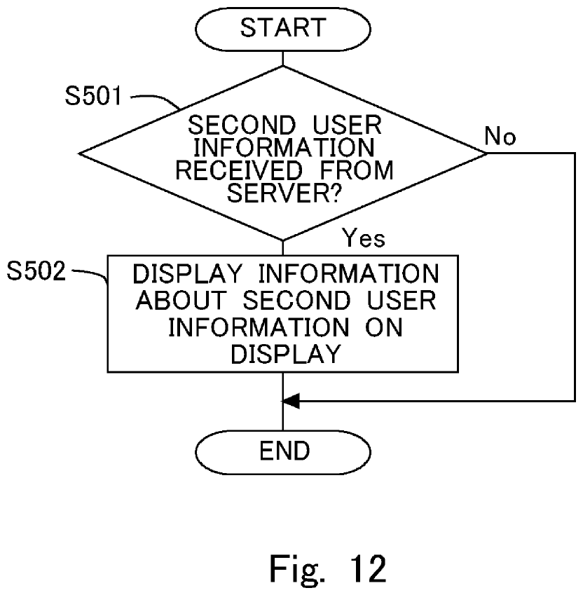

Hereafter, processing when the first user terminal 20A receives the second user information will be described. FIG. 12 is a flowchart of processing when the first user terminal 20A receives the second user information from the server 30 according to the present embodiment. The processing illustrated in FIG. 12 is executed at each predetermined time interval in the user terminal 20.

In step S501, the control unit 201 determines whether or not the second user information has been received from the server 30. When an affirmative determination is made in step S501, the processing or routine proceeds to step S502, whereas when a negative determination is made, this routine is ended. In step S502, the control unit 201 displays the second user information on the display 25. The control unit 201 displays, for example, texts “There is a user who can offer you a seat in a train departing at 10:00” and “The seat number is 12A” on the display 25. Also, for example, in cases where information about the second user who can offer his or her seat is included in the second user information, that information may be displayed on the display 25. For example, information that may be useful for specifying the second user, such as gender, age or the like, can be displayed on the display 25 so as to make it easier for the first user to find the second user. Note that the second user information may include route guidance from the current position of the first user to the current position of the second user.

As described above, according to the present embodiment, before a first user boards a train 10, the server 30 will search for a second user who can offer his or her seat in that train 10, so that the first user will have a higher possibility of getting a seat in the train 10. In addition, even if there is no second user who will offer his or her seat in the train 10 that the first user is about to board, the first user can be more sure of getting a seat by searching for another train 10 on which there is a second user who will offer his or her seat.

### Second Embodiment

In a second embodiment, a reward is given to a second user who has offered his or her seat to a first user. The reward can be, for example, electronic money, discount coupons, gift certificates, or predetermined points. Also, the reward may be a discount on the fare of the train 10. Alternatively, a reward selected by the user from a plurality of reward candidates may be given. The control unit 301 determines whether or not the second user has offered his or her seat, for example, by analyzing images taken by the camera 10A. As another alternative, in cases where information to the effect that a seat has been offered has been received from the first user terminal 20A, it is determined that the second user has offered the seat. In this case, when the first user has been offered a seat by the second user, the first user inputs that fact to the first user terminal 20A via the input unit 24. In addition, as a further alternative, the position information of the first user terminal 20A and the second user terminal 20B may be analyzed to determine whether or not the seat has been offered.

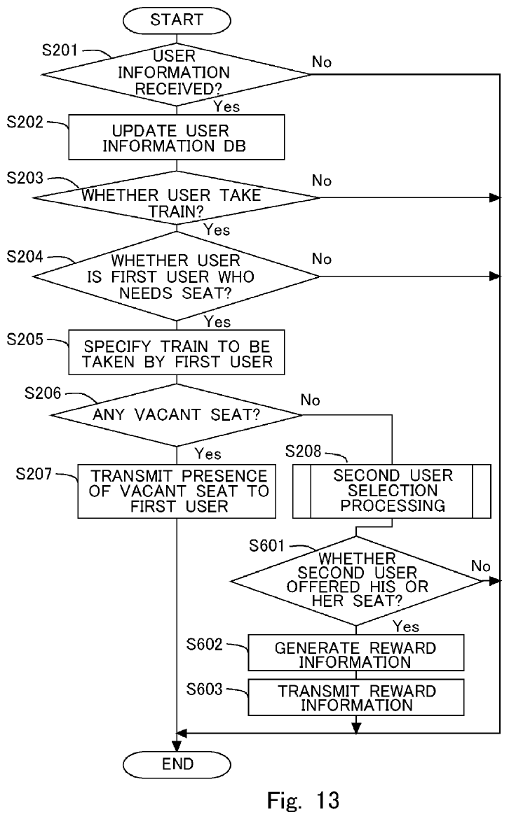

Next, processing in which the server 30 gives a reward to the second user will be described. FIG. 13 is a flowchart of processing in which the server 30 gives a reward to the second user according to the second embodiment. The processing illustrated in FIG. 13 is executed at each predetermined time interval in the server 30. Here, note that those steps in which the same processing is performed as in the flowchart illustrated in FIG. 9 are denoted by the same reference signs, and the description thereof will be omitted.

In the flowchart illustrated in FIG. 13, when the processing of step S208 is completed, the processing or routine proceeds to step S601. In step S601, the control unit 301 determines whether or not the second user has offered his or her seat to the first user. For example, the control unit 301 analyzes the images transmitted from the camera 10A to determine whether or not the second user has offered his or her seat to the first user. When an affirmative determination is made in step S601, the processing or routine proceeds to step S602, whereas when a negative determination is made, this routine is ended. Here, it should be noted that there may be a certain amount of time until the processing of step S601 starts after the processing of step S208 ends. This certain amount of time may be the time required for the second user to offer his or her seat to the first user.

In step S602, the control unit 301 generates reward information. The reward information includes information for the user to receive a reward. The reward information may have been stored in advance in the auxiliary storage unit 33 of the server 30. Then, in step S603, the control unit 301 gives the reward to the user by transmitting the reward information to the second user terminal 20B. In the second user terminal 20B that has received the reward information, the reward information is outputted to the display 25.

As described above, according to the second embodiment, a reward will be given to a second user who offers his or her seat to a first user, thus increasing the probability that the second user offers his or her seat to the first user.

### Other Embodiments

The above-described embodiments are merely examples, but the present disclosure can be implemented with appropriate modifications without departing from the spirit thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system. For example, the camera 10A or the user terminal 20 may include a part of the functions of the server 30.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium connectable to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
specifying a first user who is a user before boarding a moving vehicle;
specifying a second user who is a user sitting on a seat in the moving vehicle;
transmitting an inquiry to a terminal of the second user about whether or not to offer his or her seat; and
notifying a terminal of the first user that the first user can take a seat in the moving vehicle, when a response to the effect that a seat is offered is received from the terminal of the second user.

2. The information processing apparatus according to claim 1, wherein
the controller performs:
obtaining information about attributes of the users; and
specifying, based on the attributes of the users, a user who wants to sit on a seat in the moving vehicle as the first user.

3. The information processing apparatus according to claim 1, wherein
the controller performs:
obtaining position information about the terminal of the first user; and
specifying the moving vehicle based on the position information of the terminal of the first user.

4. The information processing apparatus according to claim 1, wherein
the controller performs:
obtaining information about a route search from the terminal of the first user; and
specifying the moving vehicle based on the information about the route search.

5. The information processing apparatus according to claim 1, wherein
the controller performs:
determining whether or not the moving vehicle has a vacant seat, based on an image taken by a camera that takes an image of an inside of the moving vehicle; and
transmitting an inquiry about whether or not to offer a seat to the terminal of the second user, when it is determined that there is no vacant seat in the moving vehicle.

6. The information processing apparatus according to claim 1, wherein
the controller performs:
obtaining position information of the terminals of the users;
specifying users who are already on board the moving vehicle, based on the position information of the terminals of the users; and
specifying the second user from among the users who are already on board the moving vehicle, based on the position information of the terminals of the users or an image taken by a camera that takes an image of an inside of the moving vehicle.

7. The information processing apparatus according to claim 6, wherein
the controller performs:
specifying, as the second user, a user who is closest to an entrance of the moving vehicle from among a plurality of users who are already on board the moving vehicle and are sitting on seats in the moving vehicle, in cases where there are the plurality of users who are already on board the moving vehicle and are sitting on the seats in the moving vehicle.

8. The information processing apparatus according to claim 1, wherein
the controller performs:
obtaining, from the terminals of users who are already on board the moving vehicle and are sitting on seats in the moving vehicle, information about attributes of the users; and
specifying the second user based on the attributes of the users who are already on board the moving vehicle and are sitting on the seats in the moving vehicle.

9. The information processing apparatus according to claim 1, wherein
the controller performs:
newly specifying a second user from among users sitting on seats in a second moving vehicle that departs later than the first-mentioned moving vehicle, in cases where a response to the effect that a seat is offered has not been received from the terminal of the second user who is sitting on a seat in the first-mentioned moving vehicle before a time point when the first user will board the first-mentioned moving vehicle;
transmitting, to a terminal of the newly specified second user, an inquiry about whether or not to offer a seat; and
notifying the terminal of the first user that the first user can take a seat in the second moving vehicle, when a response to the effect that a seat is offered has been received from the terminal of the newly specified second user.

10. The information processing apparatus according to claim 9, wherein
the controller performs:
obtaining information about a route search from the terminal of the first user; and
specifying the second moving vehicle based on the information about the route search.

11. The information processing apparatus according to claim 1, wherein
the controller performs:
transmitting a reward to the terminal of the second user, when it is detected that the second user has offered his or her seat to the first user.

12. The information processing apparatus according to claim 11, wherein
the controller performs:
detecting that the second user has offered his or her seat to the first user, based on an image transmitted from a camera that take an image of an inside of the moving vehicle.

13. An information processing method for causing a computer to perform:
specifying a first user who is a user before boarding a moving vehicle;
specifying a second user who is a user sitting on a seat in the moving vehicle;
transmitting an inquiry to a terminal of the second user about whether or not to offer his or her seat; and
notifying a terminal of the first user that the first user can take a seat in the moving vehicle, when a response to the effect that a seat is offered is received from the terminal of the second user.

14. The information processing method according to claim 13, wherein
the computer is caused to perform:
obtaining information about attributes of the users; and
specifying, based on the attributes of the users, a user who wants to sit on a seat of the moving vehicle as the first user.

15. The information processing method according to claim 13, wherein
the computer is caused to perform:
obtaining position information about the terminal of the first user; and
specifying the moving vehicle based on the position information of the terminal of the first user.

16. The information processing method according to claim 13, wherein
the computer is caused to perform:
determining whether or not the moving vehicle has a vacant seat, based on an image taken by a camera that takes an image of an inside of the moving vehicle; and
transmitting an inquiry about whether or not to offer a seat to the terminal of the second user, when it is determined that there is no vacant seat in the moving vehicle.

17. The information processing method according to claim 13, wherein
the computer is caused to perform:
obtaining position information of the terminals of the users;
specifying users who are already on board the moving vehicle, based on the position information of the terminals of the users; and
specifying the second user from among the users who are already on board the moving vehicle, based on the position information of the terminals of the users or an image taken by a camera that takes an image of an inside of the moving vehicle.

18. The information processing method according to claim 13, wherein
the computer is caused to perform:
newly specifying a second user from among users sitting on seats in a second moving vehicle that departs later than the first-mentioned moving vehicle, in cases where a response to the effect that a seat is offered has not been received from the terminal of the second user who is sitting on a seat in the first-mentioned moving vehicle before a time point when the first user will board the first-mentioned moving vehicle;
transmitting, to the terminal of the newly specified second user, an inquiry about whether or not to offer a seat; and
notifying the terminal of the first user that the first user can take a seat in the second moving vehicle, when a response to the effect that a seat is offered has been received from the terminal of the newly specified second user.

19. The information processing method according to claim 13, wherein
the computer is caused to perform:
transmitting a reward to the terminal of the second user, when it is detected that the second user has offered his or her seat to the first user.

20. A non-transitory storage medium storing a program configured to cause a computer to perform:
specifying a first user who is a user before boarding a moving vehicle;
specifying a second user who is a user sitting on a seat in the moving vehicle;
transmitting an inquiry to a terminal of the second user about whether or not to offer his or her seat; and
notifying a terminal of the first user that the first user can take a seat in the moving vehicle, when a response to the effect that a seat is offered is received from the terminal of the second user.
